(19) United States
(12) Patent Application Publication
(10) Pub. No.: US 2022/0215255 A1
(43) Pub. Date: Jul. 7, 2022

(54) LEARNING CONTENT RECOMMENDATION SYSTEM FOR PREDICTING PROBABILITY OF CORRECT ANSWER OF USER USING COLLABORATIVE FILTERING BASED ON LATENT FACTOR AND OPERATION METHOD THEREOF

(71) Applicant: RIIID INC., Seoul (KR)

(72) Inventors: Chan BAE, Seoul (KR); Jin Eon BAEK, Seoul (KR)

(73) Assignee: RIIID INC., Seoul (KR)

(21) Appl. No.: 17/646,928

(22) Filed: Jan. 4, 2022

(30) Foreign Application Priority Data
Jan. 4, 2021 (KR) 10-2021-0000117

(51) Int. Cl. G06N 3/08; G06N 7/00

(52) U.S. Cl. CPC G06N 3/08; G06N 7/005

(57) ABSTRACT

A learning content recommendation system according to an embodiment includes: a solution result data collection unit configured to communicate with a user terminal in a wired or wireless manner to collect solution result data for a problem solved by a user; a latent factor calculation unit configured to calculate one or more latent factors serving as a basis element for predicting the probability of a correct answer from the solution result data; and an embedding performance unit configured to generate, from discrete values of the solution result data, an initial embedding vector including consecutive numbers graspable by an artificial neural network on the basis of the latent factors, and weight-adjust the initial embedding vector to determine the weight-adjusted initial embedding vector as an imbedding vector to be used for training the artificial neural network.

### CROSS-REFERENCE TO RELATED APPLICATION

This application claims priority to and the benefit of Korean Patent Application No. 10-2021-0000117, filed on Jan. 4, 2021, the disclosure of which is incorporated herein by reference in its entirety.

### BACKGROUND

### 1. Field

The present invention relates to a learning content recommendation system for predicting the probability of a correct answer of a user using collaborative filtering based on a latent factor and an operation method thereof. More specifically, the present invention relates to an invention for calculating a latent factor from solution result data of a user and using the calculated latent factor as an initial embedding vector of an artificial neural network so that the learning rate and predictive performance of the artificial neural network are increased.

### 2. Discussion of Related Art

Recently, the Internet and electronic devices have been actively used in each field, and the educational environment is also changing rapidly. In particular, with the development of various educational media, learners may choose and use a wider range of learning methods. Among the learning methods, education services through the Internet have become a major teaching and learning method by overcoming time and space constraints and enabling low-cost education.

To keep up with the trend, customized education services, which are not available in offline education due to limited human and material resources, are also diversifying. For example, artificial intelligence is used to provide educational content that is subdivided according to the individuality and ability of a learner so that the educational content is provided according to the individual competency of the learner, which departs from standardized education methods of the past.

Educational content is embedded and input to be graspable by an artificial neural network. In an artificial neural network, embedding refers to vectorizing into a dimension that is the same as or lower than the original dimension. Embedding in an artificial neural network is useful due to converting thousands or tens of thousands of high-dimensional variables into hundreds of low-dimensional variables while sufficiently containing a categorical meaning even in a transformed low-dimensional space. Through embedding, the artificial neural network may find the nearest neighbor information or visualize the concept and relevance between categories and provide the result to the user.

Conventionally, a method of randomly initializing an embedding vector to be used for training an artificial neural network that predicts the probability of a correct answer of a user was used. For example, a method of randomly assigning a value between −1 and +1 based on 0 to an initial embedding vector, and adjusting the weight to minimize loss through a gradient descent algorithm, etc. to determine the final embedding vector was used.

According to the method, which uses an initial embedding vector assigned a random value, the learning time of the artificial neural network is long and the final performance is degraded.

### SUMMARY

The present invention is directed to providing a learning content recommendation system and an operation method thereof capable of increasing the learning rate and predictive performance of an artificial neural network by calculating a latent factor from solution result data of a user and using the calculated latent factor as an initial embedding vector of the artificial neural network.

The present invention is also directed to providing a learning content recommendation system and an operation method thereof capable of determining learning content to be recommended to a user through an artificial neural network with improved performance by determining the learning content to be recommended to the user on the basis of a learning content vector obtained by natural language processing of learning content data and a predicted probability of a correct answer of a user.

In addition, the present invention is also directed to providing a learning content recommendation system and an operation method thereof capable of recommending a problem that is optimized for the learning efficiency of a user by determining at least one latent factor with a collaborative filtering approach and analyzing the intrinsic meaning of the determined latent factors.

The technical objectives of the present invention are not limited to the above, and other objectives may become apparent to those of ordinary skill in the art based on the following descriptions.

According to an aspect of the present invention, there is provided a learning content recommendation system for predicting a probability of a correct answer using collaborative filtering based on a latent factor, the learning content recommendation system including: a solution result data collection unit configured to communicate with a user terminal in a wired or wireless manner to collect solution result data for a problem solved by a user; a latent factor calculation unit configured to calculate one or more latent factors serving as a basis element for predicting the probability of a correct answer from the solution result data; and an embedding performance unit configured to generate, from discrete values of the solution result data, an initial embedding vector including consecutive numbers graspable by an artificial neural network on the basis of the latent factors, and weight-adjust the initial embedding vector to determine the weight-adjusted initial embedding vector as an imbedding vector to be used for training the artificial neural network.

According to another aspect of the present invention, there is provided an operation method of a learning content recommendation system for predicting a probability of a correct answer using collaborative filtering based on a latent factor, the operation method including: collecting solution result data of a user from a user terminal and calculating a latent factor serving as a basis element for predicting the probability of a correct answer from the solution result data; generating, from the solution result data, an initial embedding vector including numbers graspable by an artificial neural network using the latent factor; weight-adjusting the initial embedding vector to generate an embedding vector to be used for training the artificial neural network and training the artificial neural network using the embedding vector; and predicting the probability of a correct answer of the user for an arbitrary problem using the trained artificial neural network and providing the user terminal with the predicted probability

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a learning problem recommendation system according to an embodiment of the present invention;

FIG. 2 is a diagram for describing a process of calculating a latent factor from solution result data through a collaborative filtering approach according to an embodiment of the present invention;

FIG. 3 is a diagram for describing a method of determining a user embedding vector using a latent factor according to an embodiment of the present invention;

FIG. 4 is a diagram for describing a method of determining a problem embedding vector using a latent factor according to an embodiment of the present invention;

FIG. 5 is a flowchart for describing an operation method of a learning problem recommendation system according to an embodiment of the present invention;

FIG. 6 is a flowchart for describing operations S505 to S507 of FIG. 5 in more detail; and

FIG. 7 is a flowchart for describing a method of determining learning content to be recommended to a user according to an embodiment of the present invention.

### DETAILED DESCRIPTION OF EXEMPLARY EMBODIMENTS

Hereinafter, embodiments of the present invention will be described in detail with reference to the accompanying drawings. In the drawings, the same parts throughout the drawings will be assigned the same number, and redundant descriptions thereof will be omitted.

It should be understood that, when an element is referred to as being “connected to” or “coupled to” another element, the element can be directly connected or coupled to another element, or an intervening element may be present. Conversely, when an element is referred to as being “directly connected to” or “directly coupled to” another element, there are no intervening elements present.

In the description of the embodiments, the detailed description of related known functions or constructions will be omitted herein to avoid making the subject matter of the present invention unclear. In addition, the accompanying drawings are used to aid in the explanation and understanding of the present invention and are not intended to limit the scope and spirit of the present invention and cover all modifications, equivalents, and alternatives falling within the spirit and scope of the present invention.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

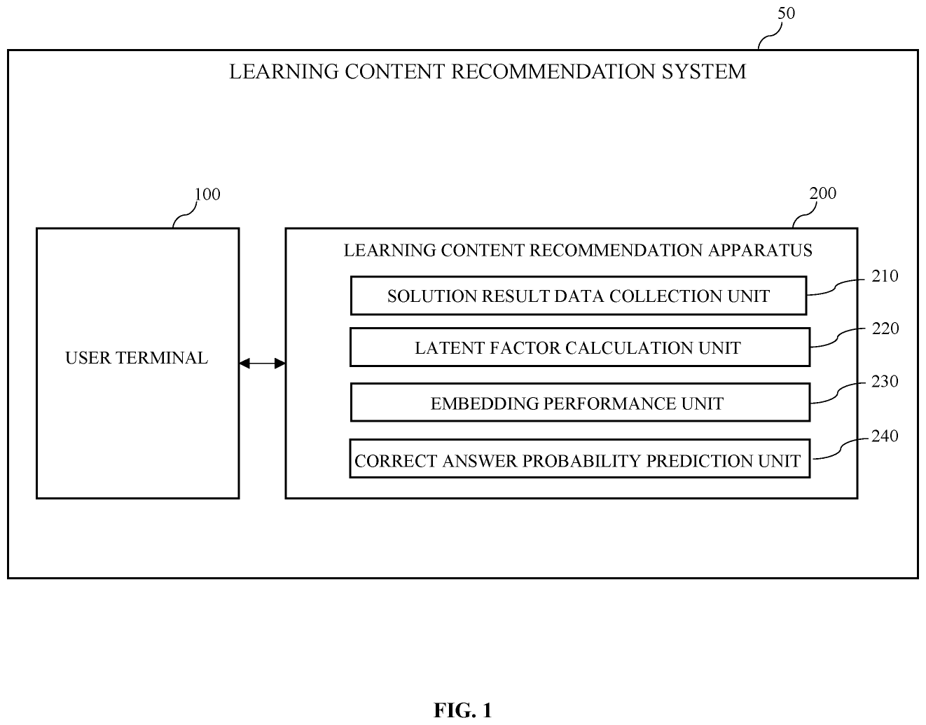

FIG. 1 is a diagram for describing a learning problem recommendation system according to an embodiment of the present invention.

Referring to FIG. 1, a learning content recommendation system 50 may include a user terminal 100 and a learning content recommendation apparatus 200.

The learning content recommendation apparatus 200 may communicate with the user terminal 100 and recommend a problem to the user and collect solution result data for the recommended problem. The collected solution result for the problem may be analyzed through an artificial neural network and used to provide users with personalized recommendation problems.

The solution result data of the user may be vectorized to be graspable by the artificial neural network and input to the artificial neural network. The vectorizing may be referred to as embedding. In an artificial neural network, embedding refers to vectorizing into a dimension that is the same as or lower than the original dimension. The embedding in artificial neural networks refers to converting thousands or tens of thousands of high-dimensional variables into hundreds of low-dimensional variables.

Conventionally, a method of randomly initializing an embedding vector to be used for training an artificial neural network that predicts the probability of a correct answer of a user was used. For example, a method of randomly assigning a value between −1 and +1 based on 0 to an initial embedding vector and adjusting the weight to minimize loss through a gradient descent algorithm, etc. to determine the final embedding vector was used.

According to the method, which uses an initial embedding vector assigned a random value, the learning time of the artificial neural network is long and the final performance is degraded.

In order to solve such a limitation, the learning content recommendation system 50 according to the embodiment of the present invention may use a collaborative filtering approach to determine an initial embedding vector.

Specifically, the learning content recommendation apparatus 200 may calculate a latent factor from solution result data of a user and use the calculated latent factor as an initial embedding vector of the artificial neural network. Hereinafter, a detailed configuration of the learning content recommendation apparatus 200 will be described in more detail.

The learning content recommendation apparatus 200 according to the embodiment of the present invention may include a solution result data collection unit 210, a latent factor calculation unit 220, an embedding performance unit 230, and a correct answer probability prediction unit 240.

The solution result data collection unit 210 may communicate with the user terminal 100 in a wired or wireless manner to collect problem solution result data of a user. In addition, the solution result data collection unit 210 may sequentially call and store previously collected pieces of solution result data of users.

The latent factor calculation unit 220 may calculate at least one latent factor from the collected solution result data. A latent factor may be an inherent element in the solution result data and may be defined as a basis element for predicting the probability of a correct answer.

Depending on the type of latent factor, a problem or user may be categorized. The learning content recommendation system 50 may identify the characteristics of the problem and the user in consideration of the type of latent factor and the value of each latent factor. Because the characteristics of the problem and the user are identified in advance through the latent factor, an artificial intelligence (AI) model may be trained more efficiently, and the accuracy of predicting the probability of a correct answer may be improved.

For example, it may be assumed that there are three latent factors calculated from solution result data. In this case, the latent factors may indicate 1) problem type (reading, listening, speaking, . . . ), 2) problem difficulty (high, medium, low), and 3) problem category (to-infinitive, gerund, preposition, topic inference, fact-finding), . . . ). This is only one example, and the meaning of the calculated latent factor may be defined in various ways according to embodiments.

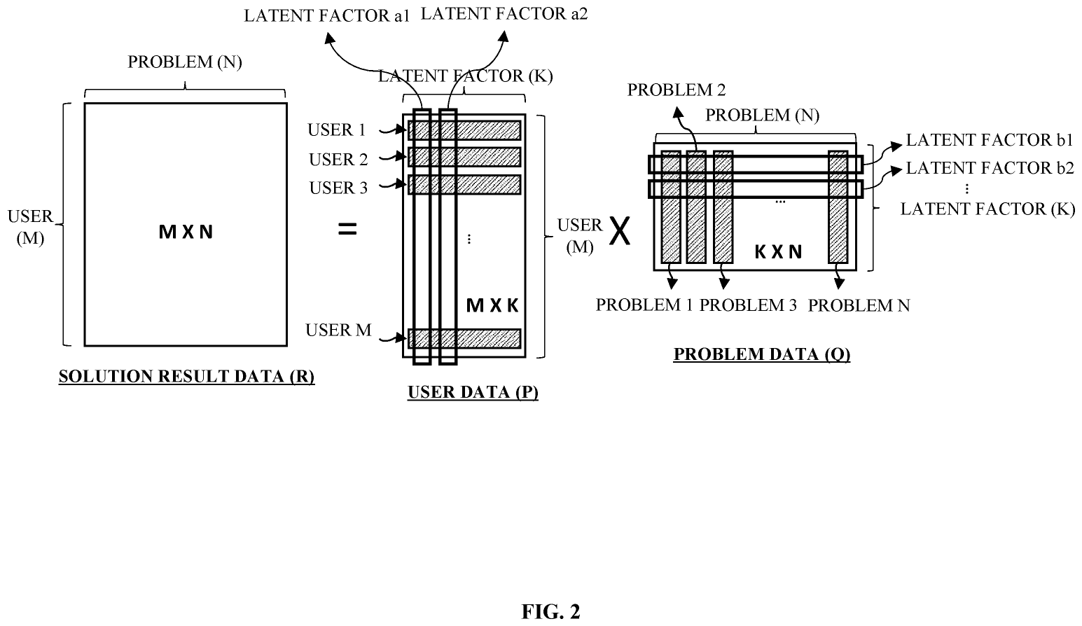

The latent factor may be calculated using various mathematical techniques. For example, the latent factor may be calculated using matrix factorization. The matrix factorization will be described in more detail with reference to FIG. 2 below.

The latent factor calculation unit 220 may adjust the number of latent factors in consideration of the performance of the artificial neural network. The number of latent factors may be arbitrarily adjusted with hyperparameters or may be adjusted by finding an optimal value through cross validation.

For example, the artificial neural network may have better performance when the number of latent factors is set to N+1 rather than when the number of latent factors is set to N. In this case, the latent factor calculation unit 220 may temporarily set the number of latent factors to N+1, and compare a case having N+1 latent factors with a case N+2 latent factors to find the number of latent factors having the optimal performance.

In addition, the latent factor calculation unit 220 may analyze the meanings of the determined latent factors and use the meanings of the determined latent factors for content recommendation. Since each latent factor contains a different meaning, each latent factor may have a different importance in user-customized problem recommendation.

The latent factor calculation unit 220, upon determining that the user's learning efficiency has been improved in response to the artificial neural network being trained with a specific latent factor assigned a weight, may determine the initial embedding vector by weighting the specific latent factor. According to an embodiment, the weighted latent factor may include one or more latent factors.

The embedding performance unit 230 may adjust the weight of the initial embedding vector generated on the basis of the latent factor to determine the final embedding vector to be used for training the artificial neural network.

Specifically, the embedding performance unit 230 may generate, from discrete values of solution result data, an initial embedding vector including consecutive numbers that are graspable by an artificial neural network on the basis of the latent factor, and may adjust the weight of the initial embedding vector to determine an embedding vector to be used for training the artificial neural network.

The embedding performance unit 230 may compare a predictive value obtained by inputting the initial embedding vector into the artificial neural network with an actual value and adjust the initial embedding vector in a direction to reduce an error between the predictive value and the actual value. This process may be repeatedly performed until the error is less than or equal to a preset value.

The above process may be referred to as weight adjustment, and as an example, the weight adjustment is performed by minimizing the error through a gradient descent algorithm to determine the final embedding vector.

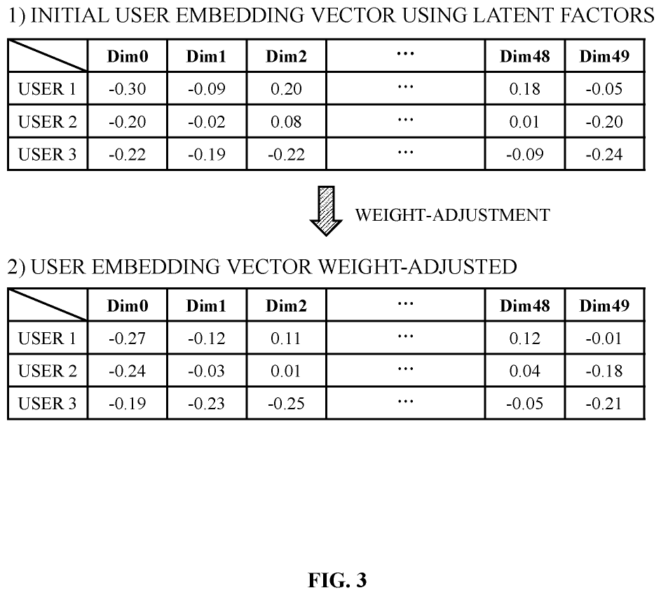

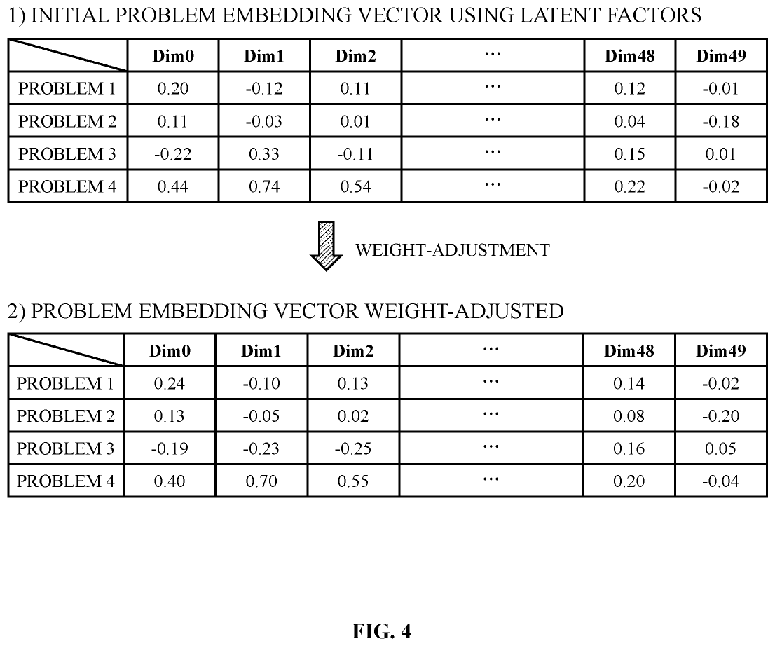

FIGS. 3 and 4 to be described below illustrate a process in which the embedding performance unit 230 determines the final embedding vector by adjusting the weight of the initial embedding vector. Specifically, FIG. 3 is a diagram for describing a process of adjusting the weight of a user embedding vector, and FIG. 4 is a diagram for describing a process of adjusting the weight of a problem embedding vector.

The correct answer probability prediction unit 240 may predict the probability of a correct answer of a user for an arbitrary problem through the artificial neural network trained with the embedding vector. The artificial neural network trained with the user embedding vector and the problem embedding vector may, when a new problem is input, predict the probability that the corresponding user answers the problem correctly.

According to a learning content recommendation method according to an embodiment of the present invention, since the viewpoint from which the artificial neural network views the problem is different from the viewpoint from which the collaborative filtering views the problem, the collaborative filtering may capture features that the artificial neural network cannot capture.

It is known that in the above-described gradient descent algorithm, the artificial neural network does not reach the global minimum and may be trapped in the local minimum. This is a problem of erroneously recognizing that update has been made with a weight at which the error is the minimum, even though the error is not minimized at the weight, in which the minimum value around a point at which weight adjustment starts is mistaken for the optimum error value.

Such a limitation of the artificial neural network may be solved by incorporating collaborative filtering. In collaborative filtering, the global minimum may be found through matrix factorization, etc., and thus limitations that may occur in artificial neural networks may be overcome through collaborative filtering.

FIG. 2 is a diagram for describing a process of calculating a latent factor from solution result data through a collaborative filtering approach according to an embodiment of the present invention.

Referring to FIG. 2, solution result data R may be expressed as an M×N matrix including M user rows and N problem columns.

The solution result data R may be decomposed into user data P and problem data Q. Assuming that there are K latent factors, the user data P may be decomposed into an M×K matrix, and the problem data Q may be decomposed into a K×N matrix.

In the embodiment of FIG. 2, each row (User 1, User 2, User 3, . . . , and User M) of the user data P may be used as an initial user embedding vector. In addition, each column of the problem data Q (problem 1, problem 2, problem 3, . . . , and problem N) may be used as an initial problem embedding vector.

The number of latent factors may be arbitrarily adjusted with hyperparameters or may be adjusted by finding an optimal value through cross validation. A latent factor may contain an intrinsic meaning that may be extracted from the solution result data.

The latent factor calculated through matrix factorization may be later used as an initial embedding vector in an artificial neural network. In this case, there is a need to determine which one of the calculated latent factors (latent factor a1, latent factor a2, latent factor b1, latent factor b2, . . . ) is to be used as the initial embedding vector.

For example, the learning content recommendation system 50 may determine latent factor a1 as the initial user embedding vector, or may determine latent factor a2 as the initial user embedding vector. For the problem data, the learning content recommendation system 50 may determine latent factor b1 as the initial problem embedding vector or may determine latent factor b2 as the initial problem embedding vector.

In an embodiment, the embedding performance unit 230 may use the calculated latent factors arbitrarily or sequentially as an initial embedding vector to train the artificial neural network model. Thereafter, the type of latent factor to be used may be determined on the basis of the performance of the trained artificial neural network for predicting the probability of a correct answer.

In another embodiment, the embedding performance unit 230 may determine the type of latent factor to be used as the initial embedding vector on the basis of the meaning of each latent factor. As described above, the embedding performance unit 230 may analyze the meaning of the latent meaning and use the meaning for content recommendation.

The learning content recommendation system 50 may use a latent factor determined to have a significant value, such as a problem category, problem type, problem difficulty, user age, user skill, etc., as an initial embedding vector.

The initial embedding vector, while the artificial neural network is being trained with initial embedding vector, may be weight-adjusted to reduce the error with an actual value to thereby be determined as, the final embedding vector.

FIG. 3 is a diagram for describing a method of determining a user embedding vector using a latent factor according to an embodiment of the present invention.

Referring to FIG. 3, with a latent factor calculated from solution result data of a user, 1) an initial user embedding vector determined from the latent factor, and 2) a user embedding vector determined by adjusting the weight of the initial user embedding vector are shown.

Conventionally, a method of randomly initializing an embedding vector to be used for training an artificial neural network that predicts the probability of a correct answer of a user was used. For example, the initial embedding vector was randomly assigned a value between −1 and +1 based on 0.

According to the above method, which uses an initial embedding vector assigned a random value, the learning time of the artificial neural network is long and the final performance is also degraded.

Referring to FIG. 3, it is shown that the weights Dim0, Dim1, Dim2, Dim48, Dim49 of the initial user embedding vectors of users 1 to 3 are assigned using the latent factor of FIG. 2 described above.

Since the weights of FIG. 3 are not a conventional arbitrary value between −1 and +1 but are assigned using a latent factor, the learning time to reach the final user embedding vector is short and the final performance is excellent.

FIG. 4 is a diagram for describing a method of determining a problem embedding vector using latent factors according to an embodiment of the present invention.

Referring to FIG. 4, similarly, the weights Dim0, Dim1, Dim2, Dim48, Dim49 of the initial problem embedding vectors of problems 1 to 4 are assigned using the latent factor of FIG. 2 described above.

Since the weights in FIG. 4 are not a conventional random value between −1 and +1 but are assigned using a latent factor, the learning time to reach the final problem embedding vector is short and the final performance is also excellent.

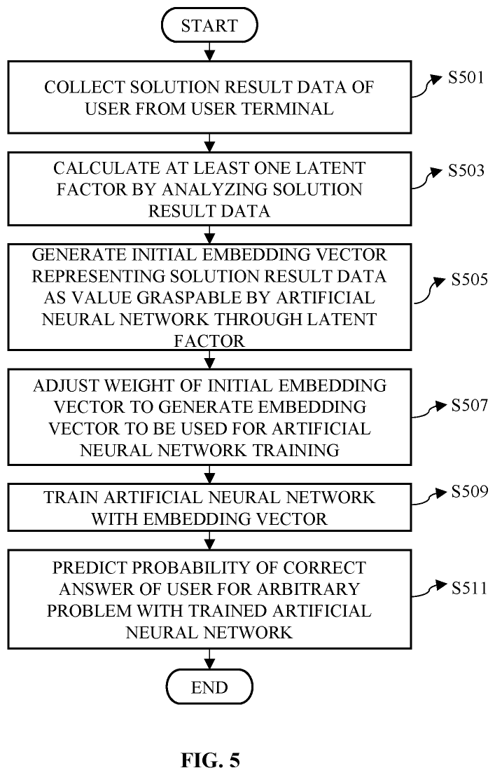

FIG. 5 is a flowchart for describing an operation method of a learning problem recommendation system according to an embodiment of the present invention.

Referring to FIG. 5, in operation S501, the learning problem recommendation system may collect solution result data of a user from the user terminal. In addition, the learning problem recommendation system may sequentially call and store previously collected pieces of solution result data of users.

In operation S503, the learning problem recommendation system may calculate at least one latent factor by analyzing the collected pieces of solution result data. The latent factors may be calculated using matrix factorization.

The number of latent factors may be adjusted in consideration of the performance of the artificial neural network. The number of latent factors may be arbitrarily adjusted with hyperparameters or may be adjusted by finding an optimal value through cross validation.

In operation S505, the learning problem recommendation system may generate an initial embedding vector representing the solution result data as a value that may be graspable by an artificial neural network through the latent factor.

Then, in operation S507, the learning problem recommendation system may perform weight-adjustment on the initial embedding vector to generate a final embedding vector to be used for artificial neural network training. The embedding vector may include a problem embedding vector and a user embedding vector.

The weight adjustment is a method of comparing a predicted value obtained by inputting the initial embedding vector into the artificial neural network with an actual value and adjusting the initial embedding vector in a direction to reduce the error. This process may be repeatedly performed until the error is less than or equal to a preset value.

In operation S509, the learning problem recommendation system may perform training on the artificial neural network with the embedding vector. Thereafter, in operation S511, the learning problem recommendation system may predict the probability of a correct answer of a user for an arbitrary problem using the trained artificial neural network.

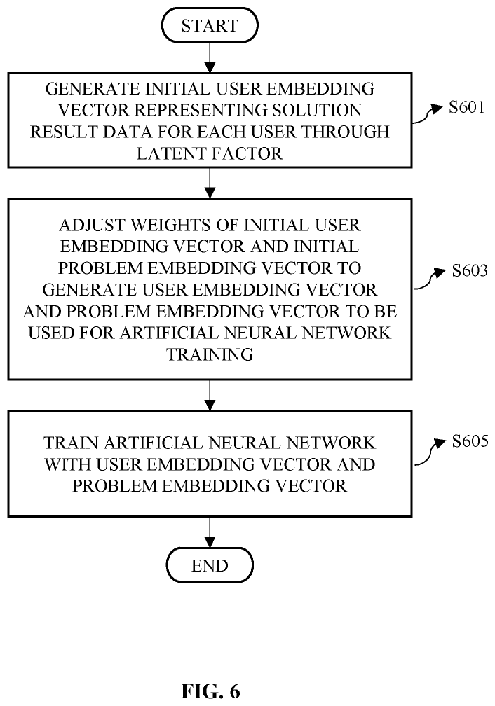

FIG. 6 is a flowchart for describing operations S505 and S507 of FIG. 5 in more detail.

Referring to FIG. 6, in operation S601, the learning content recommendation system may generate an initial user embedding vector representing solution results for each user through a latent factor. In addition, the learning content recommendation system may generate an initial problem embedding vector representing solution result data for each problem through a latent factor.

The generated initial user embedding vector and initial problem embedding vector may be input to the artificial neural network. In operation S603, the learning content recommendation system may adjust the weights of the initial user embedding vector and the initial problem embedding vector to generate a final user embedding vector and a final problem embedding vector to be used for training the artificial neural network.

Thereafter, in operation S605, the user embedding vector and the problem embedding vector may be input to the artificial neural network and used for learning to predict the probability of a correct answer.

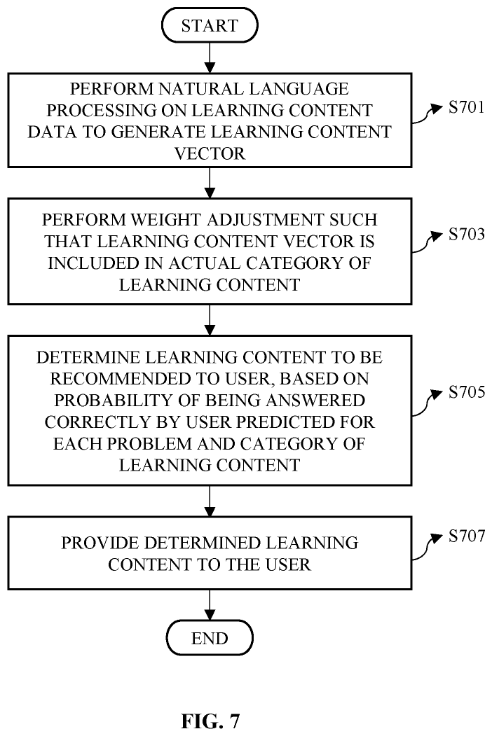

FIG. 7 is a flowchart for describing a method of determining learning content to be recommended to a user according to an embodiment of the present invention.

Referring to FIG. 7, in operation S701, the learning content recommendation system may perform natural language processing on learning content data to generate a learning content vector.

In operation S703, the learning content recommendation system may perform weight adjustment such that the learning content vector is included in an actual category of learning content. Specifically, the learning content vector may be weight-adjusted such that the error between a predicted value and an actual value is less than a preset error so as to be included in a category corresponding thereto.

In operation S705, the learning content recommendation system may determine learning content to be recommended to a user on the basis of the probability of being answered correctly by the user that is predicted for each problem and the category of learning content.

For example, when a problem with a low probability of a correct answer is determined as a recommendation problem, at least one of problems included in a category of learning content including the corresponding problem may be determined as a problem to be accompanied and recommended.

In operation S707, the learning content recommendation system may provide the determined learning content to the user.

The learning problem recommendation system according to the present invention and the operation method can determine learning content to be recommended to a user through an artificial neural network with improved performance by determining learning content to be recommended to the user on the basis of a learning content vector obtained by natural language processing of learning content data and a predicted probability of being answered correctly by the user.

As is apparent from the above, the learning content recommendation system and an operation method thereof according to the present invention can increase the learning rate and predictive performance of an artificial neural network by calculating a latent factor from solution result data of a user and using the calculated latent factor as an initial embedding vector of the artificial neural network.

The learning content recommendation system and an operation method thereof according to the present invention can determine learning content to be recommended to a user through an artificial neural network with improved performance by determining learning content to be recommended to the user on the basis of a learning content vector obtained by natural language processing of learning content data and a predicted probability of a correct answer of a user.

The learning content recommendation system and an operation method thereof according to the present invention can recommend a problem that is optimized for learning efficiency of a user by determining at least one latent factor with a collaborative filtering approach and analyzing the intrinsic meaning of the determined latent factor.

Specific embodiments are shown by way of example in the specification and the drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

What is claimed is:

1. A learning content recommendation system for predicting a probability of a correct answer using collaborative filtering based on a latent factor, the learning content recommendation system comprising:
a solution result data collection unit configured to communicate with a user terminal in a wired or wireless manner to collect solution result data for a problem solved by a user;
a latent factor calculation unit configured to calculate one or more latent factors serving as a basis element for predicting the probability of a correct answer from the solution result data; and
an embedding performance unit configured to generate, from discrete values of the solution result data, an initial embedding vector including consecutive numbers graspable by an artificial neural network on the basis of the latent factors, and weight-adjust the initial embedding vector to determine the weight-adjusted initial embedding vector as an imbedding vector to be used for training the artificial neural network.

2. The learning content recommendation system of claim 1, wherein the latent factor calculation unit is configured to adjust the number of the latent factors in consideration of performance of the artificial neural network, analyze a meaning of the latent factor, and use the meaning for content recommendation.

3. The learning content recommendation system of claim 2, wherein the latent factor calculation unit is configured to, upon identifying that a learning efficiency of the user has improved in response to the artificial neural network being trained with a specific latent factor assigned a weight, weight the specific latent factor to generate the initial embedding vector.

4. The learning content recommendation system of claim 3, wherein the embedding performance unit is configured to compare a predictive value obtained by inputting the initial embedding vector with an actual value and perform weight-adjustment on the initial embedding vector in a direction to reduce an error between the predictive value and the actual value, wherein the weight adjustment is repeatedly performed until the error is less than or equal to a preset value.

5. The learning content recommendation system of claim 4, wherein the embedding performance unit trains an artificial neural network model randomly or sequentially using the latent factors and ultimately determines a type of the latent factor to be used as the initial embedding vector on the basis of performance of the trained artificial neural network model for predicting the probability of a correct answer.

6. The learning content recommendation system of claim 5, further comprising a correct answer probability prediction unit configured to predict the probability of a correct answer of a user for an arbitrary problem through the artificial neural network trained through the embedding vector.

7. The learning content recommendation system of claim 6, wherein the initial embedding vector includes an initial user embedding vector representing the solution result data for each user through the latent factor and an initial problem embedding vector representing the solution result data for each solution through the latent factor, and
the embedding vector includes a user embedding vector, which is obtained by weight-adjusting the initial user embedding vector, and a problem embedding vector obtained by weight-adjusting the initial problem embedding vector.

8. An operation method of a learning content recommendation system for predicting a probability of a correct answer using collaborative filtering based on a latent factor, the operation method comprising:
collecting solution result data of a user from a user terminal and calculating a latent factor serving as a basis element for predicting the probability of a correct answer from the solution result data;
generating, from the solution result data, an initial embedding vector including numbers graspable by an artificial neural network using the latent factor;
weight-adjusting the initial embedding vector to generate an embedding vector to be used for training the artificial neural network and training the artificial neural network using the embedding vector; and
predicting the probability of a correct answer of the user for an arbitrary problem using the trained artificial neural network and providing the user terminal with the predicted probability.
